(19) United States
(12) Patent Application Publication
(10) Pub. No.: US 2006/0169730 A1
(43) Pub. Date: Aug. 3, 2006

(54) System and method for supporting an object behind a seat

(76) Inventor: Mark D. Morrison, Stamford, CT (US)

Correspondence Address: Hayes Soloway PC, 175 Canal Street, Manchester, NH, 03101, US

(21) Appl. No.: 11/047,398

(22) Filed: Jan. 31, 2005

(51) Int. Cl. B60R 7/00; A47C 7/62

(52) U.S. Cl. 224/275; 224/42.38; 297/188.06; 297/188.2

(57) ABSTRACT

A support device and method to provide releasable support for an object behind a seat. The support device contains a holding element capable of resting on a substantially vertical surface of a back of the seat. The support device also contains a restraining element having a first end and a second end, where the first end of the restraining element is attached to the holding element. A support element is also located within the support device, the support element being attached to the second end of the restraining elements.

### FIELD OF THE INVENTION

The present invention is generally related to the field of automotive accessories and, more particularly, to a support device for supporting an object behind a seat.

### BACKGROUND OF THE INVENTION

Currently, there is a trend of adding accessories in the passenger compartment of an automobile to make a commute, or a long trip, more comfortable or with a greater variety of entertainment. These accessories are targeted both to the driver and the passenger in the automobile. One of such accessories is a DVD (Digital Versatile Disc, formerly known as Digital Video Disc) player, which allows passengers to watch a movie inside the vehicle.

Adding a DVD player to the interior of the vehicle is cumbersome. Usually, the DVD player is not a standard accessory that may come factory-installed. Therefore, a vehicle owner or user depends on a vehicle dealership, or a specialized technician, to have the DVD player installed, or the user installs the DVD player in a do-it-yourself manner. Such installation involves a safe mounting of the DVD player, making connections for direct current (DC) power and to existing speakers of the vehicle, mounting a monitor (usually on the ceiling of the passenger compartment), routing and securing of the required wiring, etc. The complexity of such installation is significant because, on the one hand, the appearance of the interior of the vehicle should remain practically unaltered and, on the other hand, the new wiring must be done in a safe and concealed manner so that no occupant of the vehicle is placed in a hazardous situation, regardless of the vehicle in a moving or stationary state.

It is commonplace to find a DVD-ROM (DVD-Read Only Memory) drive in a portable or laptop computer. The DVD-ROM drive is capable of playing a recorded movie, just as a regular DVD player. The laptop computer may have integral speakers and a monitor. If used in a vehicle, the laptop computer is supported on the lap of a user or generally supported by the limbs of the user. A sufficiently prolonged use of the laptop computer may overheat the laptop computer enough to cause discomfort to the user. In addition, a position for comfortably supporting the laptop is difficult to find. If the laptop computer is supported by the body of the user, the user may become tired or fatigued.

Hardware has been developed for mounting items in a vehicle, some of which may be suitable for laptop computers. Unfortunately, existing hardware, or accessories, suitable for holding a laptop computer inside the vehicle have many limitations.

Currently, a vehicle seat assembly exists having a multiple-axis pivoting tray table, however, the tray table may not be removed from the vehicle seat because the tray table is integral with the vehicle seat. Therefore, the tray table may not be removed from the vehicle if so desired.

There are portable storage units for location on a vehicle seat. The portable storage unit has a tray with a writing surface, however, the portable storage unit does not have a surface to support a laptop computer at the rear of the vehicle seat. The portable storage unit also occupies a passenger seat, thereby restricting the vehicle seating capacity. Moreover, the bottom of the portable storage unit requires a flexible container containing weighted material for stabilization purposes.

Desks also exist for use in a vehicle. One example of a desk has a slide that is selectively movable towards the driver of the vehicle, however, the desk does not have a surface to support a laptop computer at the rear of the vehicle seat. Further, a seat belt is required to secure the desk.

Thus, a heretofore unaddressed need exists in the marketplace to address the aforementioned deficiencies and inadequacies.

### SUMMARY OF THE INVENTION

Embodiments of the present invention provide a support device and a method for releasably supporting at least one object behind a seat.

Briefly described, in architecture, one embodiment of the support device, among others, can be implemented as follows. The present invention is directed to a support device for releasably supporting an object behind a seat. The support device contains a holding element capable of resting on a substantially vertical surface of a back of the seat. The support device also contains a restraining element having a first end and a second end, where the first end of the restraining element is attached to the holding element. A support element is also located within the support device, the support element being attached to the second end of the restraining elements.

The present invention can also be viewed as providing a method for removably securing a support device to a seat, where the support device comprises a holding portion, a restraining element comprising a first elongated member and a second elongated member, where the support device is connected to the first elongated member, and a support element. The method comprising the steps of: pivotably removing the holding portion from the second elongated member; situating the holding portion on a first side of at least one vertical support of a headrest attached to the seat; and connecting the holding portion to the second elongated member, so that the holding portion rests against the vertical support of the headrest, wherein the support element rests on a second side of the vertical support.

Other systems, apparatus, methods, features, and advantages of the present invention will be, or become, apparent to one with skill in the art upon examination of the following drawings and detailed description. It is intended that all such additional systems, apparatus, methods, features, and advantages be included within this description, be within the scope of this invention, and be protected by the accompanying claims.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of the support device, in accordance with a first exemplary embodiment of the invention.

FIG. 2 is a perspective view of the support device mounted on a back of a seat, in accordance with the first exemplary embodiment of the invention.

FIG. 3 is a top view of the support device, in accordance with a second exemplary embodiment of the invention.

FIG. 4 is a side view of the support device, in accordance with the second exemplary embodiment of the invention.

FIG. 5 is a perspective view of the support device supporting a portable computer in an open position on the back of a seat and headrest.

### DETAILED DESCRIPTION

The present invention provides a support device, and a method of making the support device, which can be releasably attached to a seat so as to support an object behind the seat. The support device can hold many types of items, for example but not limited to, a portable computer, behind the seat in a manner to permit viewing of a movie in a DVD format and to permit removal of the support device from behind a seat when so desired. It should be noted that the word “computer” herein is used to define any device having a memory and a processor. In addition, while the present description describes support for a laptop, one having ordinary skill in the art would appreciate that the support device may be used for supporting different objects.

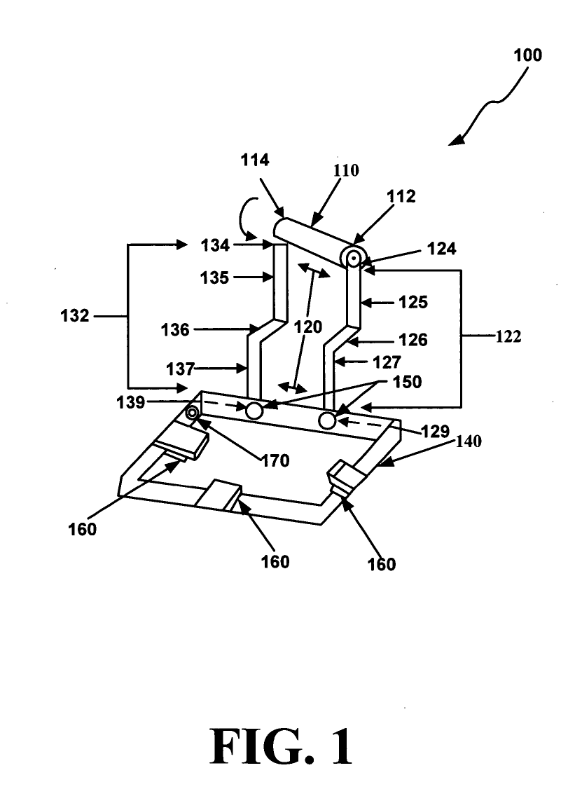

FIG. 1 is a perspective view of the support device 100, in accordance with a first exemplary embodiment of the invention. The support device 100 includes a holding element 110, a restraining element 120, a support element 140, a locking mechanism 150, a fastening element 160, and a port 170. As is shown by FIG. 1, the restraining element 120 contains a first elongated portion 122 and a second elongated portion 132. A proximate end 112 of the holding element 110 is pivotably connected to a proximate end 124 of the first elongated portion 122, while a distal end 114 of the holding element 110 is removably connected to a proximate end portion 134 of the second elongated portion 132. It should be noted that, in accordance with an alternative embodiment of the invention, the holding element 110 may be permanently attached to the restraining element 120. As an example, a recess and a matching dovetailing protrusion, and a ball-and-socket type joint may be provided between the holding element 110 and the restraining element 120.

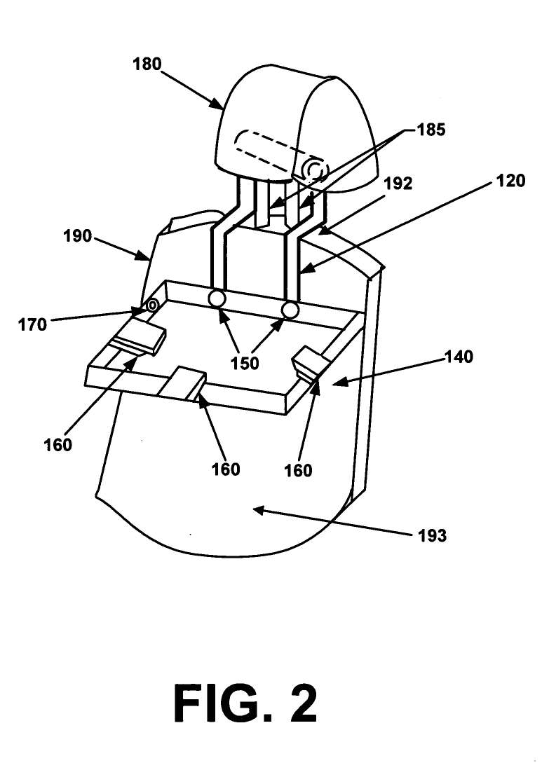

In accordance with the first exemplary embodiment of the invention, the first and second elongated portions 122, 132 of the restraining element 120 are shaped so that a top portion 125 of the first elongated portion 122 and a top portion 135 of the second elongated portion 132 extend in a vertical direction; a middle portion 126 of the first elongated portion 122 and a middle portion 136 of the second elongated portion 132 extend in a vertical direction; and a bottom portion 127 of the first elongated portion 122 and a bottom portion 137 of the second elongated portion 132 extend in a vertical direction. The general shape of the restraining element 120 allows the middle portion 126 of the first elongated portion 122 and the middle portion 136 of the second elongated portion 132 to rest on a top portion 192 (FIG. 2) of a seat 190 (FIG. 2), while the bottom portion 127 of the first elongated portion 122 and the bottom portion 137 of the second elongated portion 132 rest against a back 193 (FIG. 2) of the seat 190 (FIG. 2).

A distal end 129 of the first elongated portion 122 and a distal end 139 of the second elongated portion 132 are connected to the support element 140 via the locking mechanisms 150. Many different types of locking mechanisms 150 may be used in accordance with the first exemplary embodiment of the invention. As an example, the locking mechanism 150 may be a screw and nut assembly or the locking mechanism may simply be welding of the support element 140 to the restraining element 120.

The port 170 is provided on the support element 140 to allow different cords to traverse through the port 170 and to a laptop residing on the support element 140. In addition, fastening elements 160 may be used to secure the laptop to the support element. Examples of such fastening elements 160 may be clips, or a resistive rubber where pressure is applied to the laptop to have the laptop fit into the support element 140, thereby providing resistance in removal of the laptop from the support element 140. It should be noted that the port 170 and the fastening elements 160 are both optional features of the support device 100.

FIG. 2 is a perspective view of the support device 100, in accordance with the first exemplary embodiment of the invention, mounted on the back 193 of the seat 190. As is shown by FIG. 2, the holding element 110 is hidden by a headrest 180 due to the holding element 110 being situated underneath the headrest 180. In addition, the holding element 110 rests against vertical supports 185 of the headrest 180. Therefore, due to location of the holding element 110 and shape of the restraining element 120, the weight of a laptop when resting on the support element 140 causes the holding element 110 to press against the vertical supports 185. For purposes of stability, a user of the support device 100 may push down on the headrest 180 to secure the holding element 110 beneath the headrest 180.

It should be noted that in certain automotive vehicle seats 190, a separate or detachable headrest 180 may not exist. That is, such seats 190 instead have a taller back by having a headrest 180 integral with the back of the seat 190. In such cases, the holding element 110 may be dimensioned to grip the seat 190 in a secure manner utilizing friction or gravity.

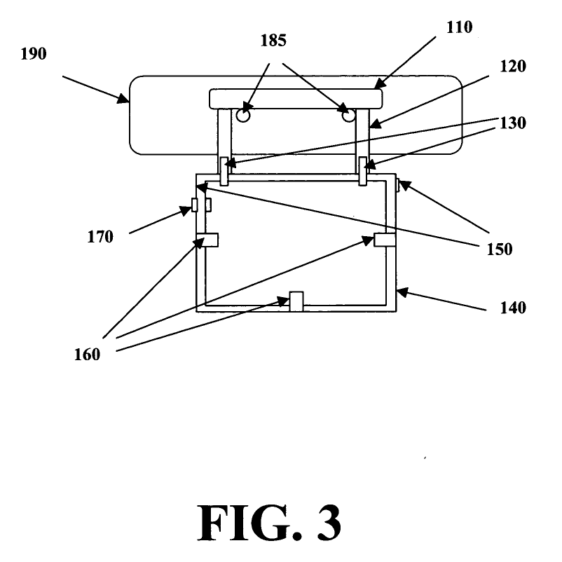

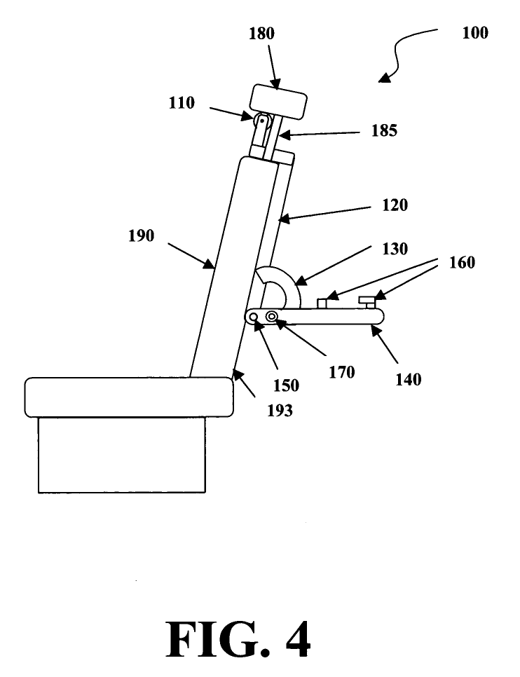

FIG. 3 is a top view of the support device 100, in accordance with a second exemplary embodiment of the invention. In addition, FIG. 4 provides a side view of the support device 100, in accordance with the second exemplary embodiment of the invention. The top view is shown with the headrest 180 removed in order to better illustrate the holding element 110. The holding element 110 is resting against the vertical supports 185 of the headrest 180. The restraining element 120 is attached to the holding element 110 and the support element 140 is attached to the restraining element 120. The restraining element 120 may have adjustable dimensions to provide a range of heights for the support element 140 for a convenient view and for permitting the support device 100 to close, against the back of the seat 190, having a short thickness beyond the surface of the substantially vertical back 193 of the seat 190, thereby occupying a low volume of leg room between adjacent seats 190.

In accordance with the second exemplary embodiment of the invention, a reinforcing element 130 may be provided near where the restraining element 120 attaches to the support element 140. Specifically, the restraining element 120 and the support element 140 are slidably connected to the reinforcing element 130. The purpose of the reinforcing element 130 is to make the support device 100 more robust for accommodating heavier objects, therefore, the reinforcing element 130 may have another design obvious to one having ordinary skill in the art. In addition, the reinforcing element 130 and the locking mechanism 150, in the second exemplary embodiment of the invention, replace the locking mechanism 150 alone of the first exemplary embodiment of the invention. Specifically, the reinforcing element 130 is connected to the restraining element 120 and the support element 140 in a manner that allows a portion of the support element 140 to be angled toward or away from the headrest 180, thereby increasing or decreasing an angle between the support element 140 and the back 193 of the seat 190. The locking mechanism 150 is capable of locking angling of the support element 140 and stabilizing the support element 140 at any angle with respect to the restraining element 120.

It should be noted that, while FIG. 4 shows the reinforcing element 130 as being curved, the reinforcement element 130 may have a different shape, as long as the support element 140 may be rotated toward or away from the back 193 of the seat 190. In addition, different devices may be used to provide angling, folding, and opening capability to the support device 100. As an example, the reinforcement element 130 may be a strong hinging mechanism, rotatably connecting the support element 140 to the restraining element 120, which is capable of providing resistance to movement of the support element 140 when the locking mechanism 150 is engaged.

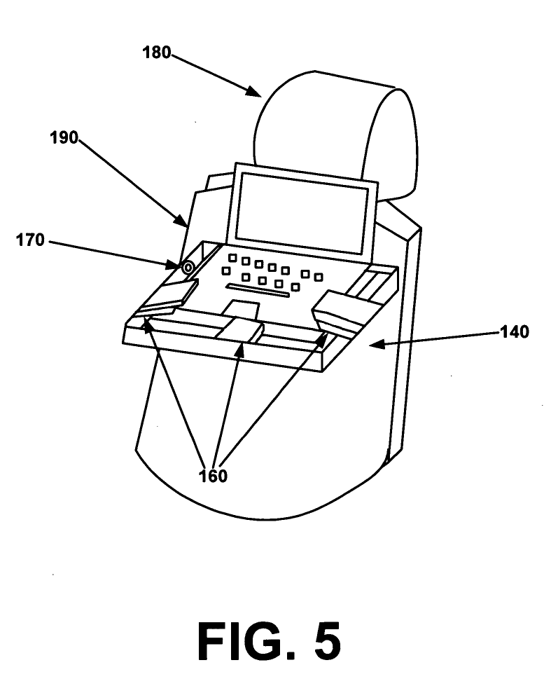

FIG. 5 is a perspective view of the support device 100 supporting a portable computer in an open position on the back of the seat 190 and the headrest 180. The portable computer is resting on the support element 140. The fastening elements 160 have been applied on the portable computer. The port 170 is shown at the left of the portable computer.

It should be emphasized that the above-described embodiments of the present invention are merely examples of implementation, merely set forth for a clear understanding of the principles of the invention. Many variations and modifications can be made to the above-described embodiments of the invention without departing substantially from the spirit and principles of the invention. All such modifications and variations are intended to be included herein within the scope of this disclosure and the present invention. The following claims protect all such modifications and variations.

What is claimed is:

1. A support device to releasably support at least one object behind a seat, the support device comprising:
a holding element capable of resting on a substantially vertical surface of a back of the seat;
a restraining element having a first end and a second end, the first end of the restraining element being attached to the holding element; and
a support element being attached to the second end of the restraining elements.

2. The support device of claim 1, wherein the restraining element is integral with the holding element.

3. The support device of claim 1, wherein a portion of the holding element is releasably connected to a portion of the restraining element, so as to allow the support device to be removed from the seat, via the holding element, without disassembling the seat.

4. The support device of claim 3, wherein the holding element is elongated in shape and capable of applying pressure on the substantially vertical surface when the support device is positioned on the seat.

5. The support device of claim 3, wherein the restraining element further comprises a first elongated member and a second elongated member, a proximate portion of the elongated member being pivotably connected to the holding element, a proximate portion of the second elongated member being removably connected to the holding element, a distal portion of the first elongated member being connected to the support element, and a distal portion of the second elongated member being connected to the support element.

6. The support device of claim 5, wherein the first elongated member and the second elongated member each further comprise:
a top portion being vertical and having the proximate portions thereon;
a middle portion extending horizontal to the top portion; and
a bottom portion extending vertical to the middle portion,
wherein the middle portion of the first elongated member and the middle portion of the second elongated member both rest on a top portion of the seat.

7. The support device of claim 3, further comprising a reinforcing element connected to the restraining element and the support element for purposes of providing additional stability to the support device.

8. The support device of claim 7, wherein the reinforcing element is capable of allowing the support element to be angled toward or away from the holding element.

9. The support device of claim 8, further comprising at least one locking mechanism capable of locking the reinforcing element so as to prevent the support element from being further angled toward or away from the holding element.

10. The support device of claim 1, further comprising a fastening element for holding said object on said support element.

11. The support device of claim 1, wherein the support element further comprises at least one port therein, for allowing a cord to fit therein.

12. The support device of claim 1, wherein the substantially vertical surface is at least one vertical support for supporting a headrest on the seat.

13. A method for removably securing a support device to a seat, wherein the support device comprises a holding portion, a restraining element comprising a first elongated member and a second elongated member, where the support device is connected to the first elongated member, and a support element, the method comprising the steps of:
pivotably removing the holding portion from the second elongated member;
situating the holding portion on a first side of at least one vertical support of a headrest attached to the seat; and
connecting the holding portion to the second elongated member, so that the holding portion rests against the vertical support of the headrest, wherein the support element rests on a second side of the vertical support.

14. The method of claim 13, further comprising the step of situating a device on the support element.

15. The method of claim 14, further comprising the step of holding the device to the support element with a fastening element.

16. The method of claim 13, further comprising the step of adjusting the support element so as to change an angle between the support element and a back of the seat, thereby bringing an end of the support element closer or further away from the holding portion.
